(19) United States
(12) Patent Application Publication
(10) Pub. No.: US 2026/0119505 A1
(43) Pub. Date: Apr. 30, 2026

(54) SYSTEMS AND METHODS FOR OPTIMIZING COMPOUND RULE EXECUTION FOR BIG DATA

(71) Applicant: Capital One Services, LLC, McLean, VA (US)

(72) Inventors: Ravi RANE, Ashburn, VA (US); Andrew LI, Arlington, VA (US); Joshua ZEID, Arlington, VA (US); Abhishek GHOSH, Glen Allen, VA (US); Ramesh JITTA, Ashburn, VA (US)

(73) Assignee: Capital One Services, LLC, McLean, VA (US)

(21) Appl. No.: 18/927,807

(22) Filed: Oct. 25, 2024

(51) Int. Cl. G06F 16/2455

(52) U.S. Cl. CPC G06F 16/24564

(57) ABSTRACT

Systems and methods for uses and/or improvements to executing complex multi-step rule execution against big data. Prompts may be parsed to extract rule sets formed of Boolean expressions. These rules can be executed individually against datasets and the results of the rules can be cached. The cached results can be used upon generation of a compound rule, thereby enabling a simplified execution of custom rules. The techniques further resolve issues involving evaluations of various expression subgroupings and logical operators, while also improving performance by eliminating duplicate rule execution and circular dependencies.

### BACKGROUND

Big data refers to a field of technology that develops advanced techniques for processing and storing large datasets (e.g., 103 or more data items, 106 or more data items, 109 or more data items, etc.). These large datasets are, generally, too large to be processed or stored using traditional methods. For example, as datasets become more granular, the prompts used to query these datasets become more specific. This can lead to performance issues when trying to determine how to process complex rules involving multiple operators and subgroupings. Rules can assert an expected state of a dataset (or portion thereof), which will either “pass” or “fail” the rule. Furthermore, the rules cannot include references due to the additional performance degradation the references cause, as well as leading to circular references.

### SUMMARY

Systems and methods are described herein for novel uses and/or improvements to rule execution engines, particularly in the realm of big data. As one example, systems are described herein for transforming complex database querying rules, such as those involving one or more nested expressions, into a compound rule (e.g., including simplified Boolean rules), whose values can be cached in advance for expedient data retrieval at runtime. This creates practical and distinct technical advantages, for example, reducing times associated with querying databases and reducing computing resource consumption.

Developing rules engines that achieve such a practical benefit must overcome several technical challenges. For example, the rules require a user to write code, which itself requires a deep understanding of the technical domain. Different programming languages may use different symbols, characters, signs, representations, etc., therefore the user will need to be able to develop and program the rules engine in the appropriate programming language(s). Additionally, a user needs to understand the functional and physical configurations of large-scale databases. Some databases include memory distributed about a number of different physical computing devices, which can also be stored at different geographical locations. Knowing how to access these databases requires an understanding of the logical and physical architecture of the databases.

In addition to these initial user prerequisites, there are numerous technical problems to overcome. For example, different users may write rules in different ways (and with different languages), and therefore the custom rules that a rules engine receives can be too overly complex to read, maintain, and/or execute. As another example, different operators, expressions, and programming languages can have different ways of grouping expressions and logical operations. Depending on the operators used, the precedence of various operations can differ and therefore how the rules engine evaluates the rules can change. This can lead to performance issues when a rule is evaluated. As still another example, because complex rules can involve one or more expressions that repeat elsewhere in the rule, the rules engine can end up performing the same evaluation multiple times, wasting computing resources, memory, slowing the evaluation process, and increasing costs. These problems can be exacerbated when those rules include references, which can further degrade performance by creating circular dependencies.

The systems and methods overcome these problems by building a rules engine that can support various logical operations while leveraging expression trees for evaluations. The expression tree approach enables the complex expression to be evaluated, analyzed, and transformed systematically, enabling subgroupings and duplicative expressions to be identified and combined when possible. This can reduce overall CPU and memory footprint, which can reduce cost associated with infrastructure. Furthermore, the rules engine can leverage machine learning to measure semantic similarities within the custom rule's text to identify duplicative expressions.

With respect to the technical problem of reducing consumption of computing resources when executing database queries, such as when querying “big data,” the rules engine can identify expressions representing binary rules within the original rule and evaluate data items against these binary rules. The rules engine further creates a compound rule that includes the logical operations from the original rule, whose structure is retained but now is transformed to operate on the Boolean values produced by the evaluation of each data item against each binary rule, as opposed to performing the complex expression evaluation at runtime. The binary rules can be evaluated at runtime. The results of the binary rules evaluations can be cached to evaluate the complex expression. Furthermore, by evaluating the compound rule using an expression tree approach, the complex rule is now replaced with a set of simplified evaluations of binary values. This advantageously allows for the results of similar evaluations to be recycled, which can reduce/eliminate computing resources being used for duplicative rule evaluations.

The systems and methods described herein further reduce processing times by caching the binary values generated from evaluating each data item against each rule. The rules engine can access the cached binary values associated with each data item to quickly evaluate the compound rule. Further improvements in performance are obtained by using expression tree approaches to systematically evaluate the compound rules. This evaluation can produce compound values, which can be stored in an updated reference table, including the previously determined cached binary values. The updated reference table can be used to develop even more complex rules that can be evaluated without raising computing costs.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRA WINGS

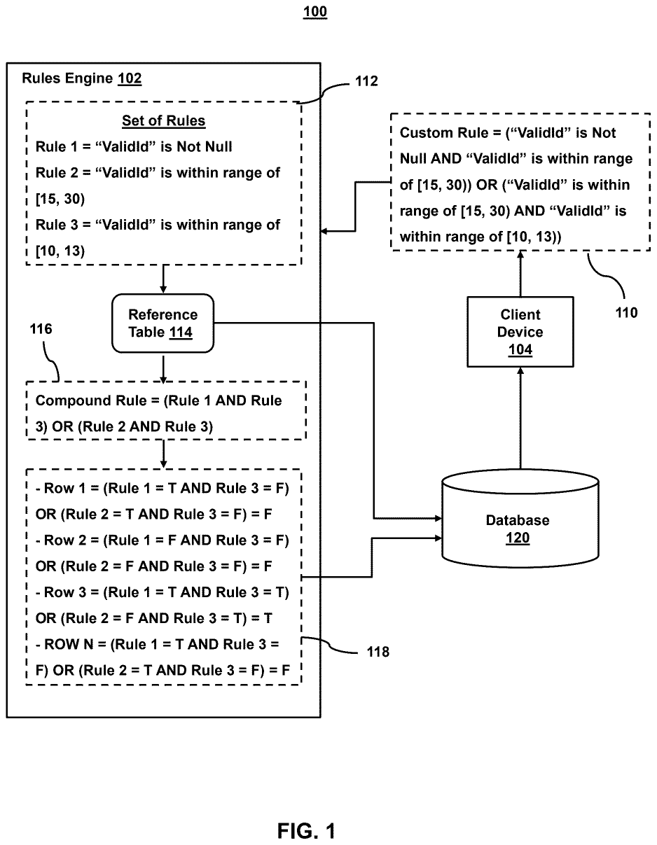

FIG. 1 shows an illustrative system for optimizing execution of complex multi-step rules against data items, in accordance with one or more embodiments.

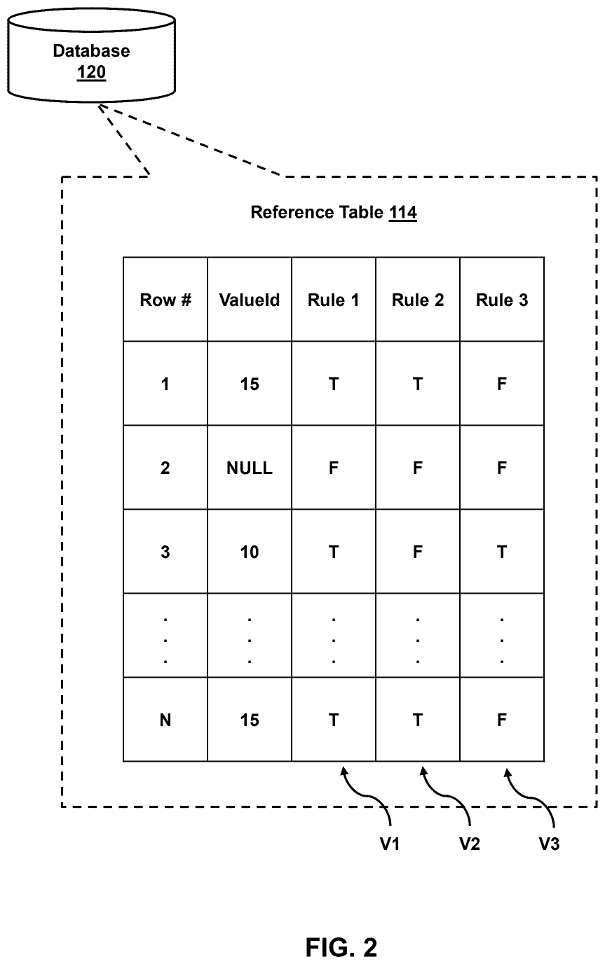

FIG. 2 shows an illustrative diagram of a reference table, in accordance with one or more embodiments.

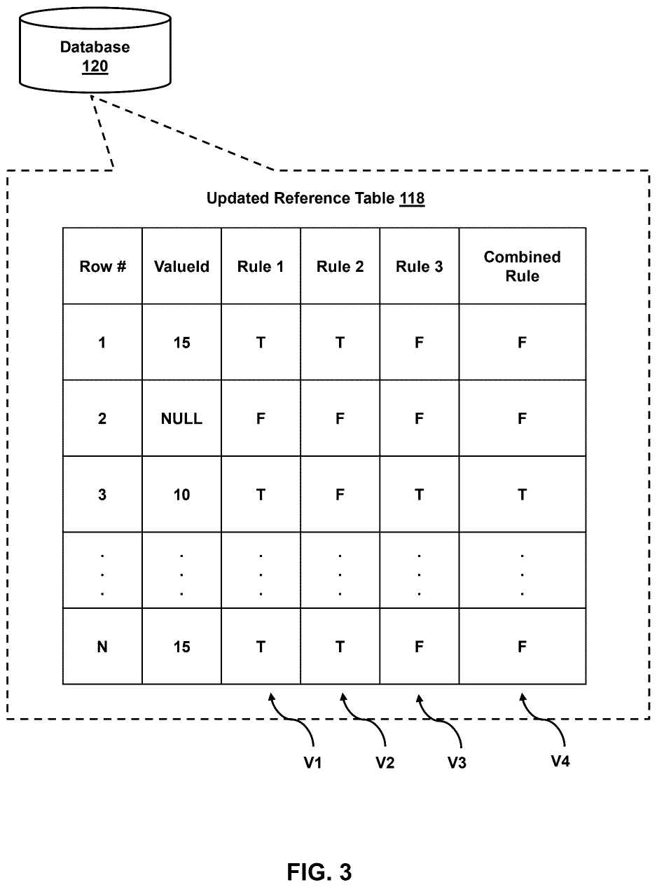

FIG. 3 shows an illustrative diagram of an updated reference table, in accordance with one or more embodiments.

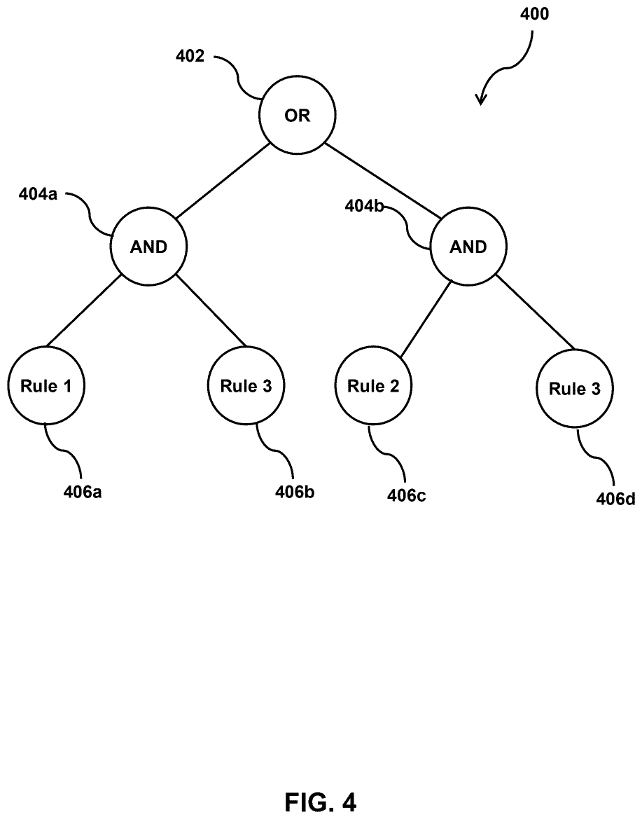

FIG. 4 shows an illustrative diagram of an expression tree and evaluation order, in accordance with one or more embodiments.

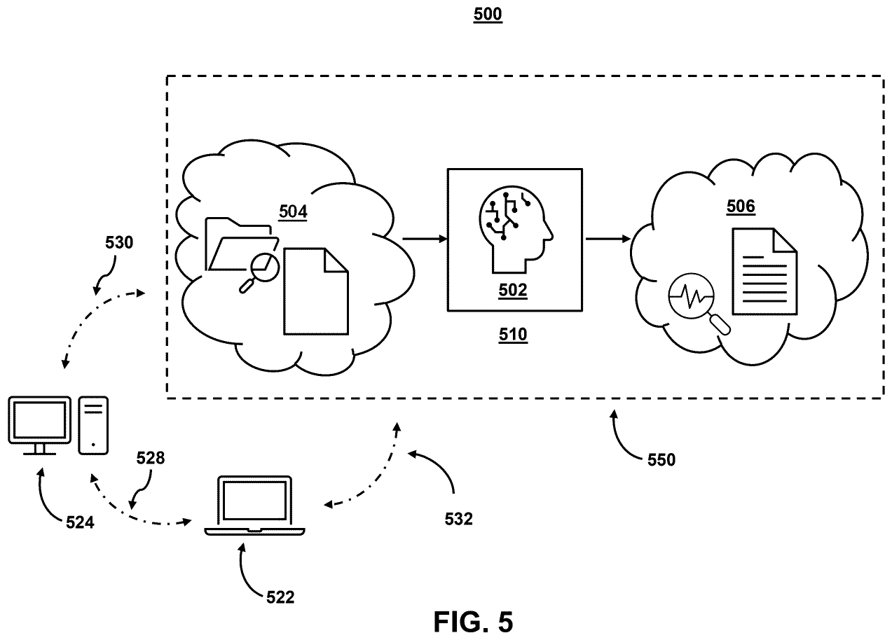

FIG. 5 shows illustrative components of a system for optimizing execution of complex multi-step rules against data items, in accordance with one or more embodiments.

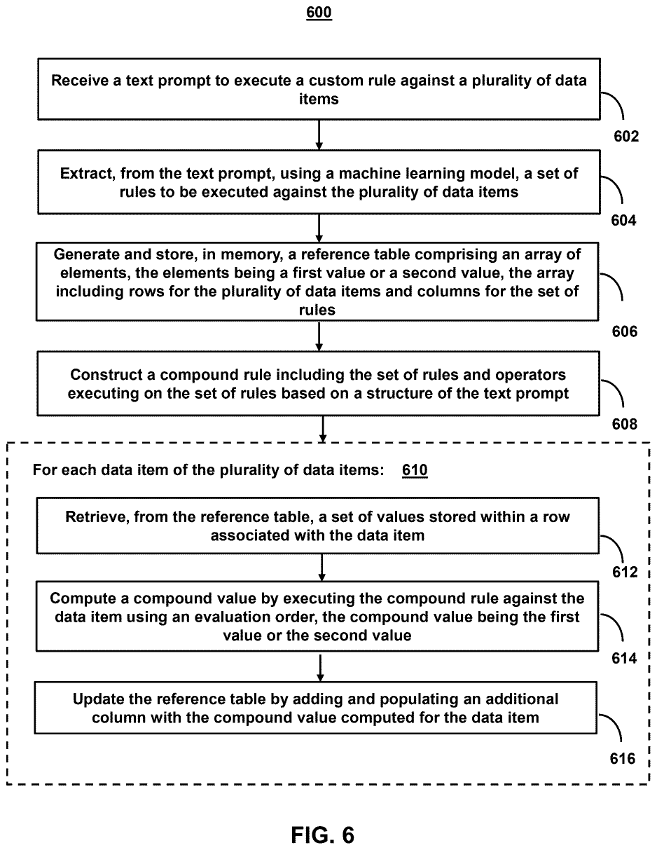

FIG. 6 shows a flowchart of the steps involved in optimizing execution of complex multi-step rules against data items, in accordance with one or more embodiments.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

Systems and methods are described herein for novel uses and/or improvements to rules execution engines, particularly as it relates to computing hardware consumption, memory footprint, and cloud compute resource usage. As one example, systems are described herein for developing and executing a rules engine configured to reduce overall CPU and memory footprint, reduce costs associated with additional cloud compute instances, improve performance results (e.g., by reducing duplicate rules being executed, reducing/eliminating circular references), and allow increased prompt complexity for granular queries of big datasets.

Processing systems for big data, such as Apache Spark, utilize in-memory caching and optimized query execution to evaluate queries against data. One of the advantages of Apache Spark is that by using in-memory processing, the number of steps needed to evaluate a query can be reduced. Additionally, Spark processing speed and caching/reusing compound rule results can drastically improve quality check performance. Furthermore, the in-memory processing enables data to be reused. This is particularly useful when analyzing rules against large datasets including thousands to millions, billions, or more, data items.

Unfortunately, technical problems arise as the rules increase in complexity. For example, as rules involve more operators and more subgroupings of expressions (i.e., nested expressions), various performance related issues can develop. These technical problems can be a result of the lack of a defined approach for evaluating the various nested expressions. Furthermore, if the rules include other rules (e.g., pointers), then the evaluation can lead to circular references that further degrade performance.

Current techniques are unable to solve these technical problems. For example, while solutions are available to support simple rules executed against large datasets, there is a lack of support established for handling complex rules. There is also no native support for reusing a prior rule's execution result when similar rules needed to be evaluated multiple times. Furthermore, there are no existing solutions that allow users to build multiple constraint rules within an execution that supports all logical operands and is customizable.

Described herein are technical solutions for overcoming these—and other—technical problems. For example, the technical solutions include developing and implementing a rules engine designed to evaluate compound rules, such as those involving multiple operators (e.g., three or more logical operators) and/or multiple (nested) expressions (e.g., four or more expressions). The rules engine may include modules, packages, or other programming that can be executed against datasets. In some examples, the rules engine may use object-oriented programming languages, such as C, C++, Python, Scala, or others. The rules engine may support various operators, such as AND, OR, NOR, XOR, or other logical operands.

In some embodiments, the rules engine may include instructions for generating expression trees for evaluating rules against large datasets. Expression trees, such as N-ary trees, are hierarchical data structures representing the syntactic structure of mathematical expressions and/or logical expressions. In expression trees, each node can correspond to an operand or a function (e.g., logical operator). The edge between two nodes represents the relationship of those nodes. Another benefit of using an expression tree is that expression trees have multiple traversal algorithms that can be used to determine an order with which the nodes of the tree, and the data stored by those nodes, are to be evaluated.

The rules engine described herein facilitates numerous technical advantages not possible with other rules engines or combinations of rules engines. For example, the rules engine does not require SQL expressions, such as the WHERE expression. Instead, the rules engine can be implemented using simple programming languages, such as, for example, Scala, to quickly build complex logical expressions. Furthermore, the rules engine can support complex subgroupings of expressions. Further still, the evaluation of such complex rules can be evaluated at the leaf level without impacting overall performance.

The rules engine overcomes many of the technical problems mentioned above. For example, compound rules can be easily defined, read, maintained, and processed using the disclosed rules engine. Furthermore, because duplicative expressions can be identified, processing costs can be saved by using previously executed simple expressions cached in reference tables. This further reduces cloud compute costs by reducing the amount of cloud computing resources needed to execute these complex rules.

FIG. 1 shows an illustrative system 100 for optimizing execution of complex multi-step rules against data items, in accordance with one or more embodiments. System 100 may include a rules engine 102, a client device 104, a database 120, and/or other components. Rules engine 102, client device 104, and database 120 may be configured to communicate with one another or one or more additional devices, servers, systems, etc., using one or more networks (e.g., the Internet, private networks, satellite communication networks, etc.). Although a single instance of each of rules engine 102, client device 104, and database 120 are depicted within FIG. 1, persons of ordinary skill in the art will recognize that additional instances of rules engine 102, client device 104, and database 120 may be included within system 100.

Rules engine 102 and client device 104 may correspond to computing systems including memory, processors, I/O circuitry, and the like. In some embodiments, rules engine 102 and client device 104 may be similar devices (e.g., personal computers), whereas some examples include rules engine 102 being implemented using cloud compute infrastructure and client device 104 being implemented using a mobile computing system (e.g., laptop, tablet, smartphone, etc.).

Database 120 may store a plurality of records capable of being operated on by one or more rules (e.g., custom rules, binary rules, compound rules). Database 120 may, alternatively or additionally, store reference tables, machine learning models, training data for training machine learning models, lookup tables, and/or other data that can be accessed by rules engine 102 and/or client device 104.

In some embodiments, each record may include a plurality of data items. For example, each of record may include N data items, where N can be 10 or more, 100 or more, 1,000 or more, 1,000,000 or more, and the like. Records may include multiple types of data items. Each record may refer to a particular type of data item. For example, records may include data items related to the type of data item “DataSetId,” the type of data item “DataSetVersion,” the type of data item “DataSetType,” and the type of data item “ValidId.” In some examples, a single record may include data items having values for multiple types of data items (e.g., data items related to two or more types of data items). For example, a given record may store values for two or more different types of data items (e.g., {“DataSetId”: Null} and {“DataSetType”: ‘OneLake’).

Database 120 may be implemented using cloud compute resources, distributed computing systems, or other computing storage. Furthermore, some embodiments include using a decentralized network of storage devices to store some or all of the records in database 120. Further still, in some embodiments, rules engine 102 and/or database 120 may form a component of a server. In some examples, the server may be associated with a service offered to a user of client device 104. In such cases, client device 104 may host a mobile application for interfacing with the server, and thus rules engine 102 and/or database 120.

As illustrated in FIG. 1, a prompt 110 may be received. For example, prompt 110 may be a text prompt submitted from a user operating a client device, such as client device 104. The prompt (e.g., text prompt) may be an instruction to execute a custom rule against a plurality of data items. As an example, prompt 110 may comprise the following expression:

$$Custom Rule = ( “ ValidId ” is Not Null AND$$

$$“ ValidId ” is within range of [ 15 , 30 ) ) OR$$

$$( “ ValidId ” is within range of [ 15 , 30 ) AND$$

$$“ ValidId ” is within range of [ 10 , 13 ) )$$

In some examples, the custom rule includes nested expressions operated on using one or more of the operators. A nested expression refers to an expression that, itself, includes expressions and operators. For example, the nested expression (“ValidId” is Not Null AND “ValidId” is within range of [15, 30)) OR (“ValidId” is within range of [15, 30) AND “ValidId” is within range of [10, 13)) includes a first logical operator (e.g., logical operator OR) operating on a first nested expression (“ValidId” is Not Null AND “ValidId” is within range of [15, 30)) and a second nested expression (“ValidId” is within range of [15, 30) AND “ValidId” is within range of [10, 13)). The first nested expression itself includes a second logical operator (e.g., logical operator AND) that operators on a first expression (e.g., “ValidId” is Not Null) and a second expression (e.g., “ValidId” is within range of [15, 30)). The second nested expression itself includes a third logical operator (e.g., logical operator AND) that operates on a third expression (e.g., “ValidId” is within range of [15, 30)) and a fourth expression (e.g., “ValidId” is within range of [10, 13)).

In some embodiments, rules engine 102 may be configured to parse text prompt 110. For example, one or more machine learning models may be used to execute natural language processing on text prompt 110 to detect expressions and operators. In some examples, text prompt 110 may be segmented, based on one or more detected delimiters, to identify text strings. Each text string may include one or more characters. Using the natural language processing, these text strings can be resolved to entities, such as logical operators (e.g., AND, OR), relational operators (e.g., <, >, =), n-grams (e.g., “Null,” “DataSetId,” “range,” etc.), characters (e.g., “Null,” “DataSetId,” “range,” “10,” “[,” etc.), and the like.

Using the machine learning model(s), rules engine 102 may be configured to extract, from text prompt 110, the first, second, third, and fourth expressions. In some embodiments, the machine learning models may be trained to convert the first, second, third, and fourth expressions into a set of rules. For example, rules engine 102 may transform text prompt 110 into a set of rules 112. In some examples, each expression may be transformed into a rule, i.e., the first expression, “ValidId” is Not Null, corresponding to a first rule, the second expression, “ValidId” is within range of [15, 30), corresponding to a second rule, the third expression, “ValidId” is within range of [15, 30), corresponding to a third rule, and the fourth expression, “ValidId” is within range of [10. 13), corresponding to a fourth rule.

Rules engine 102 may be further configured to use the same or additional machine learning models to compute a similarity of each expression. For example, the first expression may be compared to the second, third, and fourth expressions to determine their similarities. If two or more expressions are found to be similar to one another, this can indicate to rules engine 102 that computational resources can be saved by re-using previously determined results for those matching expressions' corresponding rules. For example, text prompt 110 may include two separate expressions reciting a same rule, i.e., the second expression, “ValidId” is within range of [15, 30), corresponding to the second rule, the third expression, “ValidId” is within range of [15, 30), corresponding to the third rule. Thus, in some examples, results of the third rule can be filled in with results computed for the second rule, thereby reducing execution of duplicative rules. For example, a semantic similarity between the expressions may be computed (e.g., a word2vec similarity value). If the semantic similarity is greater than a threshold similarity (e.g., greater than 85% similar, greater than 95% similar, etc.), then this can indicate that those expressions represent the same rule. For example, the third rule may be replaced with instances of the second rule (or vice versa) when constructing the compound operator due to their semantic similarity. Thus, set of rules 112 may include the first rule, second rule, and third rule, removing the duplication from the set.

In some embodiments, rules engine 102 may use a machine learning model to extract, from text prompt 110, set of rules 112 to be executed against data items, such as data items stored in database 120. In some examples, parsing text prompt 110 may include identifying rule text strings representing each of the set of rules and operator text strings representing each of the operators. For example, within each expression, the characters may be classified as relating to an operator (e.g., a relational operator, such as “>,” “=,” “<,” a logical operator, such as AND, OR, and the like), or to components of the expression to be operated on by one or more operators. In some cases, the operator text strings may be words representing an operator (e.g., the logical operator AND can be represented as a 3-letter word) or characters representing the operator (e.g., the logical operator AND can alternatively be represented in some programming languages as “&&”). The evaluation order of the set of rules and the operators may be determined based on the rule text strings and the operator text strings within the text prompt.

Each logical operator may have precedence, associativity, or other characteristics. For example, the precedence of a logical operator may be determined based on a type of operation performed by that operator. In some examples, the evaluation order may be determined based on a ranking of the operators. The ranking, for example, may be based on the precedence of each of the operators. The compound rule may then include the set of rules and the operators structured based on the ranking. The associativity of an operator may indicate how operators of the same precedence are ground together in an expression. Operators can be left-associative, right-associative, or both. Left-associative operators group operations from the left, whereas right-associative operators group operations from the right. As an example, multiplication and addition are operations that have left and right associativity.

In some embodiments, the machine learning model may include one or more artificial intelligence models (i.e., arranged as an ensemble model), and at least one of these artificial intelligence models executes natural language processing on the text prompt to extract the set of rules. Furthermore, the natural language processing may be used to identify and extract operators included within expressions represented by the text prompt.

In some embodiments, a reference table 114 comprising an array of elements may be generated and stored in memory of rules engine 102 and/or database 120. The elements of the array of reference table 114 may have a first value or a second value. For example, an element having the first value can indicate that a particular data item, when a given rule is applied thereto, satisfies that rule. If not, the element may have the second value. As an illustrative example, FIG. 2 includes an example of reference table 114. The array of elements of reference table 114 may include rows (e.g., rows 1-N) for the plurality of data items (e.g., data items 1-N) and columns for the set of rules (e.g., a column for each of Rule 1, Rule 2, and Rule 3). In some examples, an additional column may also be included to store a value of that element.

To generate reference table 114, each rule from set of rules 112 may be executed against each data item of the plurality of data items of a given record. For example, set of rules 112 may be executed against data items 1-N (e.g., ValidId=15, NULL, 10, . . . , 15). More specifically, Rule 1 can be executed by using, as the sample to be evaluated, ValidId=15, which results in an element having evaluated to be True (also labeled as “T”). This value indicates that this sample satisfies the condition specified by Rule 1. Evaluating Rule 1 for the sample ValidId=Null yields a value of False (also labeled as “F”). This value indicates that this sample does not satisfy the condition specified by Rule 1.

The result of a rule being executed against the data items may be a vector of elements, with each element being the first value or the second value based on whether the element satisfies the rule. For example, executing Rule 1 against the data items {ValidId=(15, Null, 10, . . . , 15)} may produce a vector of elements {V1=T, F, T, . . . , T}; executing Rule 2 against the data items {ValidId=(15, Null, 10, . . . , 15)} may produce a vector of elements {V2=T, F, F, . . . , T}; and executing Rule 3 against the data items {ValidId=(15, Null, 10, . . . , 15)} may produce a vector of elements {V3=F, F, T, . . . , F}. The vector of elements (e.g., vectors V1-V3) may be combined to form the array of elements stored in reference table 114.

Returning to FIG. 1, in some embodiments, rules engine 102 may be configured to construct a compound rule 116 including set of rules 112 and operators executing on set of rules 112. For example, text prompt 110 may include a first logical operator (i.e., the logical operator OR), a second logical operator (i.e., the logical operator AND), and a third logical operator (i.e., the logical operator AND). Compound rule 116 may transform text prompt 110 by replacing the text with the rules from set of rules 112, where the rules are arranged such that the logical operators operate on their corresponding rules. Using the previous example with Rule 1=“ValidId” is Not Null, Rule 2=“ValidId” is within range of [15, 30), and Rule 3=“ValidId” is within range of [10. 13), compound rule 116 may be generated taking the form:
Compound Rule=(Rule 1 AND Rule 3) OR (Rule 2 AND Rule 3)

In some examples, compound rule 116 may be constructed based on a structure of text prompt 110. For example, rules engine 102 can build compound rule 116 to ensure that the order of operators is preserved.

In some embodiments, for each of the data items, a set of values stored within a row associated with that data item may be retrieved from the reference table. For example, from Row 1, associated with ValidId=15, the set of values may include T, T, F, indicating that for ValidId=15, Rule 1 is true, Rule 2 is true, and Rule 3 is false. As another example, from Row 2, associated with ValidId=Null, the set of values may include F, F, F, indicating that for ValidId=Null, Rule 1 is false, Rule 2 is false, and Rule 3 is false. As yet another example, from Row 3, associated with ValidId=10, the set of values may include T, F, T, indicating that for ValidId=10, Rule 1 is true, Rule 2 is false, and Rule 3 is true.

Different types of operators have different precedence, which can indicate an order in which expressions should be evaluated. For simple expressions, such as those including a single operator (e.g., “ValidId” is Not Null), the order is intuitive. However, as the expressions become more complex, often involving nested expressions (e.g., (“ValidId” is Not Null AND “ValidId” is within range of [15, 30)) OR (“ValidId” is within range of [15, 30) AND “ValidId” is within range of [10, 13))), determination of the order in which operators within the expressions are to be evaluated becomes non-trivial. For example, in C-programming languages, multiplication and division operators have higher precedence than addition and subtraction operators, which can have higher precedence than logical OR operators, which can have higher precedence than logical AND operators. The precedence of a logical operator may be determined based on a type of operation performed by that operator, the associativity of the operator, or other characteristics of that operator. The evaluation order may be determined based on a ranking of the operators. The ranking, for example, may be determined based on the precedence of each of the operators. The compound rule may then be constructed to include the set of rules and the operators arranged based on the ranking.

In some embodiments, truth tables can be relied upon to determine how operators evaluate expressions. A truth table includes different combinations of binary values and the results of each combination's evaluation. For example, as seen in Table 1 below:

TABLE 1

| P | Q | P AND Q | P OR Q |
|---|---|---|---|
| F | F | F | F |
| F | T | F | T |
| T | F | F | T |
| T | T | T | T |

Returning to FIG. 1, a compound value may be computed by executing the compound rule (e.g., compound rule 116) against each of the data items. In examples where the operators are Boolean operators, the compound value may be the first value or the second value. Truth tables, such as Table 1, can be used to determine the compound values. In one or more examples, if the compound value is the first value (e.g., True), this can indicate that the data item satisfies the compound rule. However, if the compound value is the second value (e.g., False), then this can indicate that the data item fails to satisfy the compound rule.

Rules engine 102 may be configured to determine the compound value for each data item using reference table 114. However, instead of executing the customer rule (e.g., prompt 110), which may include multiple nested expressions, rules engine 102 can leverage the previously generated reference table 114 to retrieve the results of each individual rule (e.g., binary rules, having either one of two results) of set of rules 112. For example, the values for a given row (e.g., Row 1) can be input to compound rule 116 to quickly compute a compound value for a corresponding data item (e.g., ValidId=15). The compound value for each row, and thus each data item, of a given record, may be computed to form compound values.

In some embodiments, rules engine 102 can update reference table 114 based on a first or second mode of evaluation. For example, the first mode of evaluation may include a “row-based” evaluation, and the second mode of evaluation may include an “aggregate” evaluation. For the first mode of evaluation (i.e., “row-based” evaluation), rules engine 102 may be configured to update reference table 114 by adding and populating an additional column with the compound values to obtain updated reference table 118. In this mode of evaluation, rules engine 102 evaluates each data item (i.e., row). One advantage of performing a “row-based” evaluation is that it provided additional information for the data analytics report that will be output. For example, with reference to FIG. 3, rules engine 102 may be configured to generate and store updated reference table 118, including the compound values in database 120. As seen in FIG. 3, updated reference table 118 may include an additional column, V4, storing determined compound values for the N different data items. As mentioned above, the values extracted for each row of reference table 114 can be used to generate the combined value for that row's data item. Evaluating compound rule 116 with ValidId=15 may involve extracting Row 1 from reference table 114 and inserting the values stored in Row 1 into compound rule 116. For example, rules engine 102 may retrieve Row 1 from reference table 114, insert the values from Row 1 for each rule into compound rule 116 (e.g., Rule 1=T AND Rule 3=F) OR (Rule 2=T AND Rule 3=F)=F). The combined value, therefore, for Row 1 (corresponding to the data item ValidId=15) may be False. In some examples, Table 1 may be used to determine the combined values stored in updated reference table 118.

The second mode of evaluation (i.e., the “aggregate” evaluation) may include rules engine 102 evaluating rules against an aggregate result of each rule within the expression. As an example, a binary rule, such as a “Not Null” rule, where the evaluation produces one of two possible results (e.g., “Yes” if the data is not null, “No” if the data is null), may be produced for each data item and additionally an overall binary evaluation can be performed based on a number of data items that produced a given result. Evaluating using the “aggregate” mode of evaluation has certain advantages as well. For instance, the “aggregate” mode of evaluation generally consumes fewer computing resources because the computing resources necessary for evaluating the compound rule do not scale with the number of data items (e.g., rows) in the input dataset. Instead, the computing resources scale with the number of nested expressions. Additionally, some rules only produce a result in when evaluated using the “aggregate” mode of evaluation and do not produce a result for the “row-based” mode of evaluation (e.g. the minimum value of a field should be x). Such compound rules can only be evaluated by rules engine 102 using the “aggregate” mode of evaluation.

In some embodiments, an expression tree representing compound rule 116 may be generated. As an example, with reference to FIG. 4, expression tree 400 may include a plurality of nodes, such as nodes 402, 404a-404b, and 406a-406d. Nodes 402, 404a-404b, and 406a-406d may represent the operators and the set of rules. The number of nodes included within expression tree 400 may depend on the number of expressions included within text prompt 110. For example, prompt 110 includes four expressions and three logical operators. Thus, in this example, expression tree 400 includes seven nodes.

In some examples, expression tree 400 may be an N-ary expression tree. N-ary expression trees include nodes where each node has N, or fewer, child nodes. For example, an N=2 tree, also referred to as a binary tree, has at most two child nodes descending therefrom. N-ary trees, in particular, can be advantageous to use because the operations can be executed in logarithmic time. There are different types of N-ary trees that may be used. For example, a full N-ary tree, where each node has either 0 or N child nodes, a complete N-ary tree, where the nodes at each level have exactly N child nodes except the last level, a perfect N-ary tree, where each level includes a same number of child nodes.

The expression tree can be hierarchically organized based on a type of operator of each of the operators. Each type of operator can have an associated precedence indicating a sequence with which the operators are to operate on the set of rules. For example, in most programming languages derived from C, the logical operator NOT has a higher precedence than the logical operator AND, which has a higher precedence than the logical operator OR. In some embodiments, the expression tree may be generated by assigning each of the operators and each rule of the set of rules to a node within the expression tree based on the precedence of the operator. As an example, node 402 of expression tree 400 represents the logical operator OR, and nodes 404a-404b both represent the logical operator AND. Nodes 404a-404b descend from node 402. In some examples, node 402 is referred to as a root node and nodes 404a-404b are referred to as child nodes. Nodes 406a-406d represent each rule from set of rules 112. For example, nodes 406a-406d, respectively, correspond to Rules 1-3.

In some embodiments, rules engine 102 may determine an evaluation order to be used to evaluate the expression tree. Different traversal techniques can be used to determine the order with which nodes of a tree will be evaluated. For example, an “Inorder” traversal may be executed using an example “inorder” traversal algorithm (e.g., 1) Traverse left subtree; 2) Visit root node; 3) Traverse right subtree). As another example, a “preorder” traversal may be executed using an example “preorder” traversal algorithm (e.g., 1) Visit root node; 2) Traverse left subtree; 3) Traverse right subtree). As yet another example, a “postorder” traversal may be executed using an example “postorder” traversal algorithm (e.g., 1) Traverse left subtree; 2) Traverse right subtree; 3) Visit root node). As still yet another example, a “level order” traversal may be executed using an example “level order” traversal algorithm (e.g., 1) Create an empty queue; 2) Enqueue the root node; 3) Loop while the queue is not empty: i) dequeue a node from the queue and visit that node; ii) enqueue the left child of the dequeued node if it exists; iii) enqueue the right child node of the dequeued node if it exists).

In some embodiments, a data analytics report may be generated and output to the user operating client device 104 as a response to text prompt 110. The data analytics report may include updated reference table 118, including the compound values computed for each data item of the plurality of data items. In some embodiments, the data analytics report may include reference table 114 and/or updated reference table 118. In some embodiments, the data analytics report may include an expression tree, such as expression tree 400, or a portion thereof. In some embodiments, the data analytics report may be formatted within a user interface or web resource for consumption by an end-user.

In some embodiments, data obtained from executing the compound rules can be used for further downstream processing and analysis. For example, the quality of the data can be analyzed in order to determine whether and/or what to provide to one or more applications, systems, and the like, for subsequent analysis. Depending on the quality of the data, different warnings, alerts, messages, workflow stops, or other actions/instructions, may be created.

FIG. 5 shows illustrative components for a system used to estimate runtime processing efficiency of serverless applications and/or provide recommendations for more efficient code for the serverless applications, in accordance with one or more embodiments. As shown in FIG. 5, system 500 may include mobile device 522 and user terminal 524. While shown as a smartphone and personal computer, respectively, in FIG. 5, it should be noted that mobile device 522 and user terminal 524 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 510. Cloud components 510 may alternatively be any computing device as described above, and may include any type of mobile terminal, fixed terminal, or other device. For example, cloud components 510 may be implemented as a cloud computing system and may feature one or more component devices. It should also be noted that system 500 is not limited to three devices. Users may, for instance, utilize one or more devices to interact with one another, one or more servers, or other components of system 500. It should be noted, that, while one or more operations are described herein as being performed by particular components of system 500, these operations may, in some embodiments, be performed by other components of system 500. As an example, while one or more operations are described herein as being performed by components of mobile device 522, these operations may, in some embodiments, be performed by components of cloud components 510. In some embodiments, the various computers and systems described herein may include one or more computing devices that are programmed to perform the described functions. Additionally, or alternatively, multiple users may interact with system 500 and/or one or more components of system 500. For example, in one embodiment, a first user and a second user may interact with system 500 using two different components.

With respect to the components of mobile device 522, user terminal 524, and cloud components 510, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 5, both mobile device 522 and user terminal 524 include a display upon which to display data (e.g., conversational responses, queries, and/or notifications).

Additionally, as mobile device 522 and user terminal 524 are shown as touchscreen smartphones, these displays also function as user input interfaces. It should be noted that in some embodiments, the devices may have neither user input interfaces nor displays and may instead receive and display content using another device (e.g., a dedicated display device such as a computer screen, and/or a dedicated input device such as a remote control, mouse, voice input, etc.). Additionally, the devices in system 500 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 5 also includes communication paths 528, 530, and 532. Communication paths 528, 530, and 532 may include the Internet, a mobile phone network, a mobile voice, or data network (e.g., a 5G or LTE network), a cable network, a public switched telephone network, or other types of communications networks or combinations of communications networks. Communication paths 528, 530, and 532 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 510 may include model 502, which may be a machine learning model, artificial intelligence model, etc. (which may be referred to collectively as “models” herein). Model 502 may take inputs 504 and provide outputs 506. The inputs may include multiple datasets, such as a training dataset and a test dataset. Each of the plurality of datasets (e.g., inputs 504) may include data subsets related to user data, predicted forecasts and/or errors, and/or actual forecasts and/or errors. In some embodiments, outputs 506 may be fed back to model 502 as input to train model 502 (e.g., alone or in conjunction with user indications of the accuracy of outputs 506, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., a lambda function, runtime efficiency, and/or alternative lambda functions).

In a variety of embodiments, model 502 may update its configurations (e.g., weights, biases, or other parameters) based on the assessment of its prediction (e.g., outputs 506) and reference feedback information (e.g., user indication of accuracy, reference labels, or other information). In a variety of embodiments, where model 502 is a neural network, connection weights may be adjusted to reconcile differences between the neural network's prediction and reference feedback. In a further use case, one or more neurons (or nodes) of the neural network may require that their respective errors be sent backward through the neural network to facilitate the update process (e.g., backpropagation of error). Updates to the connection weights may, for example, be reflective of the magnitude of error propagated backward after a forward pass has been completed. In this way, for example, the model 502 may be trained to generate better predictions.

In some embodiments, model 502 may include an artificial neural network. In such embodiments, model 502 may include an input layer and one or more hidden layers. Each neural unit of model 502 may be connected with many other neural units of model 502. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 502 may be self-learning and trained, rather than explicitly programmed, and can perform significantly better in certain areas of problem solving, as compared to traditional computer programs. During training, an output layer of model 502 may correspond to a classification of model 502, and an input known to correspond to that classification may be input into an input layer of model 502 during training. During testing, an input without a known classification may be input into the input layer, and a determined classification may be output.

In some embodiments, model 502 may include multiple layers (e.g., where a signal path traverses from front layers to back layers). In some embodiments, back propagation techniques may be utilized by model 502 where forward stimulation is used to reset weights on the “front” neural units. In some embodiments, stimulation and inhibition for model 502 may be more free flowing, with connections interacting in a more chaotic and complex fashion. During testing, an output layer of model 502 may indicate whether or not a given input corresponds to a classification of model 502 (e.g., a lambda function, runtime efficiency, and/or alternative lambda functions).

In some embodiments, the model (e.g., model 502) may automatically perform actions based on outputs 506. In some embodiments, the model (e.g., model 502) may not perform any actions. The output of the model (e.g., model 502) may be used to recommend a lambda function, runtime efficiency, and/or alternative lambda functions.

System 500 also includes API layer 550. API layer 550 may allow the system to generate summaries across different devices. In some embodiments, API layer 550 may be implemented on mobile device 522 or user terminal 524. Alternatively, or additionally, API layer 550 may reside on one or more of cloud components 510. API layer 550 (which may be a REST or Web services API layer) may provide a decoupled interface to data and/or functionality of one or more applications. API layer 550 may provide a common, language-agnostic way of interacting with an application. Web services APIs offer a well-defined contract, called WSDL, that describe the services in terms of their operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 550 may use various architectural arrangements. For example, system 500 may be partially based on API layer 550, such that there is strong adoption of SOAP and RESTful Web-services, using resources like Service Repository and Developer Portal, but with low governance, standardization, and separation of concerns. Alternatively, system 500 may be fully based on API layer 550, such that separation of concerns between layers like API layer 550, services, and applications are in place.

In some embodiments, the system architecture may use a microservice approach. Such systems may use two types of layers: Front-End Layer and Back-End Layer where microservices reside. In this kind of architecture, the role of the API layer 550 may provide integration between Front-End and Back-End. In such cases, API layer 550 may use RESTful APIs (exposition to front-end or even communication between microservices). API layer 550 may use AMQP (e.g., Kafka, RabbitMQ, etc.). API layer 550 may use incipient usage of new communications protocols such as gRPC, Thrift, etc.

In some embodiments, the system architecture may use an open API approach. In such cases, API layer 550 may use commercial or open-source API Platforms and their modules. API layer 550 may use a developer portal. API layer 550 may use strong security constraints applying WAF and DDoS protection, and API layer 550 may use RESTful APIs as standard for external integration.

FIG. 6 shows a flowchart 600 of the steps involved in optimizing execution of complex multi-step rules against data items, in accordance with one or more embodiments. For example, rules engine 102 may implement flowchart 600 (e.g., as implemented on one or more system and/or cloud-compute components described above) in order to enable execution of complex data quality rule sets against big data, reduce/eliminate errors resulting from increased quantities of expression subgroupings and evaluations of logical operands, improve performance by avoiding referencing resulting in duplicate rule execution and circular dependencies, and save computational and monetary resources by reducing a number of cloud computing instances needed.

At step 602, a text prompt to execute a custom rule against a plurality of data items may be received. As an example, with reference to FIG. 1, prompt 110 may comprise a text prompt submitted to rules engine 102 via client device 104. In one or more examples, one or more pre-processing steps may be executed upon receipt of the prompt. For example, if the prompt is received in the form of audio data, then speech recognition functionalities may be executed to transform the audio data into text data. In some examples, data representing the prompt may be reformatted, restructured, translated (e.g., from one language to another language), and the like, upon receipt of client device 104. In some examples, prompt 110 may be input via a web application or an API function of database 120.

At step 604, a set of rules, such as set of rules 112, may be extracted from the prompt (e.g., prompt 110). In some embodiments, rules engine 102 may implement one or more machine learning models to extract the set of rules from the prompt. For example, the machine learning models may parse the text of the prompt, identify characters, symbols, words, parts-of-speech (POS), and the like, determine an intent of the text (including, in some cases, one or more tasks to be performed), and populate a data structure representing the prompt for further processing and analysis. In some embodiments, the extraction of the set of rules may preserve structural information about the prompt for determining an order of evaluation of the to-be-created compound rule. For example, an indication of where a given expression is located within prompt 110, the logical operator(s) operating on that expression, and any other expressions also being operated on by the same logical operator(s).

In some embodiments, the same or different machine learning model may be further configured to determine if the rule set includes any duplicative rules. For example, each rule may comprise a string of text (e.g., including one or more expressions, one or more operands, one or more characters, etc.). Rules engine 102 may be configured to input each rule's corresponding string of text into an artificial intelligence model, such as an autoencoder or other embedding model, to generate an embedding representing the string. The embedding comprises a compressed representation of the string of text. Using the embeddings, similarity metrics between the embeddings can be determined by measuring a distance between the embeddings in an embedding space. If a given embedding is determined to be similar to another embedding, then that can indicate that the two embeddings are semantically similar. Depending on how similar the embeddings are to one another, rules engine 102 may determine whether the two rules are duplicates. As an example, referring to prompt 110, it can be seen that the second expression and the third expression include the same text. Therefore, embeddings representing those strings of text should occupy a similar space in an embedding space. In some examples, two (or more) embeddings may be considered to be similar to one another if the similarity metric representing the similarity of those embeddings' corresponding strings of text is greater than or equal to a threshold similarity (e.g., greater than or equal to 90% similar, 95% similar, and the like). The similarity of the embeddings' corresponding strings of text may indicate that an intent of those strings of text is the same or similar.

At step 606, a reference table, such as reference table 114, comprising an array of elements may be generated and stored in memory. In some examples, database 120 may include memory storing reference table 114. Alternatively, rules engine 102 may store the reference table in its memory. In some examples, rules engine 102 may store a pointer to a memory location where reference table 114 is stored.

The elements may be a first value or a second value. The elements may be one value if a given data item satisfies a given rule from the set of rules, whereas the elements may be the other value if the given data item fails to satisfy the given rule. As an example, Rule 1 from set of rules 112 may be a Boolean operation, where if a given data item's value is Null, then that data item fails Rule 1, however a non-Null data item value does not fail Rule 1. While Boolean values may be described for reference table 114, it should be understood that similar processes may be implemented for non-Boolean values.

In some embodiments, the array of elements of the reference table may include a row for each data item being evaluated. For example, with reference to FIGS. 1 and 2, because the data being analyzed includes N data items, reference table 114 includes N rows. In some examples, fewer rows may be used if one or more data items are duplicates. In the example of FIG. 2, reference table 114 may be updated in some cases to remove the N-th row as it includes a data item having a same value as another row (e.g., the first row). In some embodiments, the array of elements of the reference table may include a column for each rule in the set of rules. Continuing the previous example, reference table 114 may include a column for Rule 1, a column for Rule 2, and a column for Rule 3.

At step 608, a compound rule, such as compound rule 116, may be constructed. In some embodiments, rules engine 102 may create compound rule 116 such that it includes the set of rules (e.g., set of rules 112) and any operators identified from prompt 110 that operate on those rules. In some embodiments, rules engine 102 may create compound rule 116 such that it has a same or similar structure/organization as that of prompt 110.

At step 610, one or more sub-steps may be performed for the plurality of data items to be evaluated. Persons of ordinary skill in the art will recognize that some embodiments include performing the sub-steps for some or all of the data items. Step 610 may be performed serially or in parallel. For example, a first data item may be selected from the plurality of data items. Upon selection, rules engine 102 may extract a value associated with that data item. For example, with reference to FIG. 2, a first data item may have a value of “ValidId”=15. This value may be used by the sub-steps of step 610 to evaluate the compound rule. A second data item may also be selected, and the value associated with that data item may also be extracted (e.g., “ValidId”=Null). Rules engine 102 may execute one or more of the sub-steps of step 610 using the value of the second data item.

At sub-step 612, a set of values stored within a row associated with a given data item may be retrieved from the reference table. For example, rules engine 102 may retrieve the values stored in reference table 114 for each of the rules (i.e., for Row 1, the set of values includes “T,” “T,” “F”). In some embodiments, prior to retrieving the set of values, the reference table may be cached in local memory for quick access to the stored values. In some examples, after sub-step 612, another data item from the plurality of data items may be selected and the set of values stored within a row of the reference table for that data item may be retrieved. Alternatively, sub-step 612 may proceed to sub-step 614.

At sub-step 614, a compound value may be computed by executing the compound rule against the data item using an evaluation order. The evaluation order may be determined based on precedence, associativity, or other features of the custom rule/prompt and the resulting compound rule. The evaluation order can be used to indicate how to resolve a comparison of logical values from the reference table. For example, the order of operations and the type of operations being performed can impact the resulting compound value. As an illustrative example, using the retrieved values for Row 1 of reference table 114 (e.g., “T,” “T,” “F”), the compound value for Row 1 can be computed (e.g., Row 1=(Rule 1=T AND Rule 3=F) OR (Rule 2=T AND Rule 3=F)=F). As seen by this example, the evaluation of the first parenthetical and second parenthetical occurs before the logical operator OR is used.

At sub-step 616, the reference table can be updated by adding and populating an additional column with the compound value computed for that data item. As an example, with reference to FIG. 3, updated reference table 118 may represent reference table 114, including an additional column, labeled “Combined Rule,” that stores the compound values determined by executing compound rule 116.

In some embodiments, the compound values generated and stored in updated reference table 118 may be provided to client device 104. In some embodiments, a data analytics report may be generated and output to the user operating client device 104 as a response to text prompt 110. The data analytics report may include the compound values included in updated reference table 118. In some embodiments, the data analytics report may include reference table 114 and/or updated reference table 118. In some embodiments, the data analytics report may include an expression tree, such as expression tree 400, or a portion thereof. In some embodiments, the data analytics report may be formatted within a user interface or web resource for consumption.

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 6.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for optimizing execution of complex multi-step rules against data items.
2. The method of embodiment 1, comprising: receiving a text prompt to execute a custom rule against a plurality of data items; extracting, from the text prompt, using a machine learning model, a set of rules to be executed against the plurality of data items; generating and storing, in memory, a reference table comprising an array of elements, the elements being a first value or a second value, the array including rows for the plurality of data items and columns for the set of rules; constructing a compound rule including the set of rules and operators executing on the set of rules; for each data item of the plurality of data items: retrieving, from the reference table, a set of values stored within a row associated with the data item; computing a compound value by executing the compound rule against the data item using an evaluation order, the compound value being the first value or the second value; and updating the reference table by adding and populating an additional column with the compound value computed for the data item.
3. The method of embodiment 2, wherein extracting the set of rules using the machine learning model comprises: parsing the text prompt to identify rule text strings representing each of the set of rules and operator text strings representing each of the operators.
4. The method of embodiment 3, further comprising: determining the evaluation order of the set of rules and the operators based on the rule text strings and the operator text strings within the text prompt.
5. The method of any one of embodiment 3 or embodiment 4, wherein the operators comprise logical operators each having a precedence determined based on a type of operation performed by that operator.
6. The method of embodiment 5, wherein determining the evaluation order comprises: ranking the operators based on the precedence of each of the operators; and structuring the set of rules and the operators based on the ranking.
7. The method of any one of embodiments 2-6, wherein the machine learning model comprises one or more artificial intelligence models.
8. The method of embodiment 7, wherein at least one of the one or more artificial intelligence models executes natural language processing on the text prompt to extract the set of rules.
9. The method embodiment 7 or embodiment 8, wherein an artificial intelligence model of the one or more artificial intelligence models comprises an autoencoder trained to generate a set of embeddings representing each rule of the set of rules; for each pair of embeddings of the set of embeddings: compute a similarity metric indicating a similarity of the pair of embeddings.
10. The method of embodiment 9, further comprising: determining that a similarity metric computed using a first embedding representing a first rule of the set of rules and a second embedding representing a second rule of the set of rules satisfies a similarity condition; and responsive to determining that the similarity condition has been satisfied, removing the second rule from the set of rules.
11. The method of embodiment 10, wherein the similarity condition being satisfied comprises the similarity metric being greater than or equal to a similarity threshold score.
12. The method of any one of embodiments 2-11, wherein generating the reference table comprises: for each rule of the set of rules, execute the rule against each data item of the plurality of data items to obtain a vector of elements, each element included within the vector being the first value or the second value based on the element satisfying the rule or not satisfying the rule, respectively; and combine the vector obtained for each rule of the set of rules to form the array.
13. The method of any one of embodiments 2-12, further comprising: generating an expression tree representing the compound rule, wherein the expression tree comprises a plurality of nodes representing the operators and the set of rules.
14. The method of embodiment 13, wherein the expression tree comprises an N-ary expression tree.
15. The method of embodiment 13 or embodiment 14, wherein the expression tree is organized in a hierarchy based on a type of operator of each of the operators, wherein each type of operator has a precedence indicating a sequence with which the operators are to operate on the set of rules.
16. The method of embodiment 15, wherein generating the expression tree comprises: assigning each of the operators and each rule of the set of rules to a node within the expression tree based on the precedence of the operator.
17. The method of any one of embodiments 13-16, further comprising: determining the evaluation order based on the expression tree.
18. The method of any one of embodiments 2-17, wherein the compound value being the first value indicates that the data item satisfies the compound rule, and the compound value being the second value indicates that the data item fails to satisfy the compound rule.
19. The method of any one of embodiments 2-11, further comprising: outputting a data analytics report comprising the compound value computed for each data item of the plurality of data items.
20. The method of embodiment 19, wherein outputting the data analytics report comprises generating and sending a user interface to a client device as a response to the text prompt.
21. The method of any one of embodiments 2-20, wherein the custom rule comprises nested expressions operated on using one or more of the operators.
22. The method of embodiment 21, wherein the nested expressions comprise a first logical operator operating on a first nested expression and a second nested expression, wherein the first nested expression comprises a second logical operator operating on a first rule and a second rule, and the second nested expression comprises a third logical operator operating on a third rule and a fourth rule, wherein the set of rules comprises the first rule, the second rule, the third rule, and the fourth rule, and wherein the operators comprise the first logical operator, the second logical operator, and the third logical operator.
23. The method of embodiment 22, wherein constructing the compound rule comprises: determining that the first rule and the fourth rule are equal; and replacing the fourth rule with the first rule in the compound rule.
24. The method of embodiment 23, wherein one or more machine learning models are used to determine that the first rule and the fourth rule are equal by computing a similarity between a representation of the first rule and a representation of the fourth rule satisfying a similarity condition.
25. One or more non-transitory, computer-readable media storing instructions that, when executed by a data processing apparatus, cause the data processing apparatus to perform operations comprising those of any of embodiments 1-24.
26. A system comprising: memory storing computer program instructions; and one or more processors programmed with the computer program instructions to perform operations comprising those of any of embodiments 1-24.
27. A system comprising means for performing any of embodiments 1-24.

What is claimed is:

1. A system for optimizing execution of complex multi-step rules against data items, the system comprising:
memory storing computer program instructions and a plurality of data items, wherein the plurality of data items include at least one million data items;
one or more processors programmed to:
receive a text prompt to execute a custom rule against the plurality of data items, wherein the custom rule includes nested expressions operated on using one or more logical operators;
extract, from the text prompt, using a natural language processing model, a set of binary rules to be executed against the plurality of data items;
generate a reference table comprising an array of elements each being a first binary value or a second binary value, the array including a row for each data item of the plurality of data items and a column for each rule of the set of binary rules, and wherein the first binary value indicates that a given data item satisfies a given binary rule and the second binary value indicates that the given data item fails to satisfy the given binary rule;
cache the reference table in the memory;
construct a compound rule by replacing, within the text prompt, each of the nested expressions with a corresponding binary rule from the set of binary rules such that the one or more logical operators operate on the set of binary rules;
add an additional column to the reference table to be populated with compound values computed based on the compound rule;
generate an N-ary expression tree comprising tiers of nodes structured based on the compound rule;
determine an evaluation order for evaluating the set of binary rules using the one or more logical operators based on the N-ary expression tree;
for each data item of the plurality of data items:
retrieve, from the cached reference array, a set of binary values stored within the row associated with the data item;
compute a compound binary value by applying the one or more logical operators to the set of binary values using the evaluation order, the compound binary value being the first binary value indicating that the data item satisfies the compound rule or the second binary value indicating that the data item fails to satisfy the compound rule; and
update the reference table by populating the additional column with the compound binary value computed for the data item; and
output a data analytics report comprising the compound binary value computed for each data item of the plurality of data items.

2. A method, implemented using one or more processors, comprising:
receiving a text prompt to execute a custom rule against a plurality of data items;
extracting, from the text prompt, using a machine learning model, a set of rules to be executed against the plurality of data items;
generating and storing, in memory, a reference table comprising an array of elements, the elements being a first value or a second value, the array including rows for the plurality of data items and columns for the set of rules;
constructing a compound rule including the set of rules and operators executing on the set of rules;
for each data item of the plurality of data items:
retrieving, from the reference table, a set of values stored within a row associated with the data item;
computing a compound value by executing the compound rule against the data item using an evaluation order, the compound value being the first value or the second value; and
updating the reference table by adding and populating an additional column with the compound value computed for the data item.

3. The method of claim 2, wherein extracting the set of rules using the machine learning model comprises:
parsing the text prompt to identify rule text strings representing each of the set of rules and operator text strings representing each of the operators; and
determining the evaluation order of the set of rules and the operators based on the rule text strings and the operator text strings within the text prompt.

4. The method of claim 3, wherein the operators comprise logical operators each having a precedence determined based on a type of operation performed by that operator, wherein determining the evaluation order comprises:
ranking the operators based on the precedence of each of the operators; and
structuring the set of rules and the operators based on the ranking.

5. The method of claim 2, wherein the machine learning model comprises one or more artificial intelligence models, wherein at least one of the one or more artificial intelligence models executes natural language processing on the text prompt to extract the set of rules.

6. The method of claim 2, wherein generating the reference table comprises:
for each rule of the set of rules, execute the rule against each data item of the plurality of data items to obtain a vector of elements, each element included within the vector being the first value or the second value based on the element satisfying the rule or not satisfying the rule, respectively; and
combine the vector obtained for each rule of the set of rules to form the array.

7. The method of claim 2, further comprising:
generating an expression tree representing the compound rule, wherein the expression tree comprises a plurality of nodes representing the operators and the set of rules.

8. The method of claim 7, wherein the expression tree is organized in a hierarchy based on a type of operator of each of the operators, wherein each type of operator has a precedence indicating a sequence with which the operators are to operate on the set of rules, generating the expression tree comprises:
assigning each of the operators and each rule of the set of rules to a node within the expression tree based on the precedence of the operator.

9. The method of claim 8, further comprising:
determining the evaluation order based on the expression tree.

10. The method of claim 2, wherein the compound value being the first value indicates that the data item satisfies the compound rule, and the compound value being the second value indicates that the data item fails to satisfy the compound rule.

11. The method of claim 2, further comprising:
outputting a data analytics report comprising the compound value computed for each data item of the plurality of data items.

12. The method of claim 2, wherein the custom rule comprises nested expressions operated on using one or more of the operators.

13. The method of claim 12, wherein the nested expressions comprise a first logical operator operating on a first nested expression and a second nested expression, wherein the first nested expression comprises a second logical operator operating on a first rule and a second rule, and the second nested expression comprises a third logical operator operating on a third rule and a fourth rule, wherein the set of rules comprises the first rule, the second rule, the third rule, and the fourth rule, and wherein the operators comprise the first logical operator, the second logical operator, and the third logical operator.

14. The method of claim 13, wherein constructing the compound rule comprises:
determining that the first rule and the fourth rule are equal; and
replacing the fourth rule with the first rule in the compound rule.

15. One or more non-transitory computer-readable media storing computer program instructions that, when executed by one or more processors, effectuate operations comprising:
receiving a text prompt to execute a custom rule against a plurality of data items;
extracting, from the text prompt, using a machine learning model, a set of rules to be executed against the plurality of data items;
generating and storing, in memory, a reference table comprising an array of elements, the elements being a first value or a second value, the array including rows for the plurality of data items and columns for the set of rules;
constructing a compound rule including the set of rules and operators executing on the set of rules based on a structure of the text prompt;
for each data item of the plurality of data items:
retrieving, from the reference table, a set of values stored within a row associated with the data item;
computing a compound value by executing the compound rule against the data item using a determined evaluation order, the compound value being the first value or the second value; and
updating the reference table by adding and populating an additional column with the compound value computed for the data item.

16. The one or more non-transitory computer-readable media of claim 15, wherein extracting the set of rules using the machine learning model comprises:
parsing the text prompt to identify rule text strings representing each of the set of rules and operator text strings representing each of the operators; and
determining an ordering of the set of rules and the operators based on the rule text strings and the operator text strings within the text prompt.

17. The one or more non-transitory computer-readable media of claim 15, wherein generating the reference table comprises:
for each rule of the set of rules, execute the rule against each data item of the plurality of data items to obtain a vector of elements, each element included within the vector being the first value or the second value based on the element satisfying the rule or not satisfying the rule, respectively; and
combine the vector obtained for each rule of the set of rules to form the array.

18. The one or more non-transitory computer-readable media of claim 15, wherein the operations further comprise:
generating an expression tree representing the compound rule, wherein the expression tree comprises a plurality of nodes representing the operators and the set of rules.

19. The one or more non-transitory computer-readable media of claim 18, wherein the expression tree is organized in a hierarchy based on a type of operator of each of the operators, wherein each type of operator has a precedence indicating an order with which the operators are to operate on the set of rules, generating the expression tree comprises:
assigning each of the operators and each rule of the set of rules to a node within the expression tree based on the precedence of the operator.

20. The one or more non-transitory computer-readable media of claim 15, wherein the custom rule comprises nested expressions operated on using one or more of the operators, the nested expressions comprise a first logical operator operating on a first nested expression and a second nested expression, the first nested expression comprises a second logical operator operating on a first rule and a second rule, the second nested expression comprises a third logical operator operating on a third rule and a fourth rule, the set of rules comprises the first rule, the second rule, the third rule, and the fourth rule, and the operators comprise the first logical operator, the second logical operator, and the third logical operator, wherein constructing the compound rule comprises:
determining that the first rule and the fourth rule are equal; and
replacing the fourth rule with the first rule in the compound rule.
